(19) United States
(12) Patent Application Publication
(10) Pub. No.: US 2016/0240134 A1
(43) Pub. Date: Aug. 18, 2016

(54) PIXEL CIRCUIT AND DRIVING METHOD AND DISPLAY APPARATUS THEREOF

(71) Applicants: BOE Technology Group Co., Ltd., Beijing (CN); Beijing BOE Optoelectronics Technology Co., Ltd., Beijing (CN)

(72) Inventors: Shengji Yang, Beijing (CN); Xue Dong, Beijing (CN); Haisheng Wang, Beijing (CN); Yingming Liu, Beijing (CN); Weijie Zhao, Beijing (CN); Xiaoliang Ding, Beijing (CN)

(21) Appl. No.: 14/803,300

(22) Filed: Jul. 20, 2015

(30) Foreign Application Priority Data
Feb. 12, 2015 (CN) 201510076814.8

(51) Int. Cl. G09G 3/32

(52) U.S. Cl. CPC G09G 3/3225; G09G 3/3266; G09G 2300/0426; G09G 2330/028; G09G 2330/027; G09G 2310/061

(57) ABSTRACT

A pixel circuit and a driving method and display apparatus thereof are provided, which relate to the field of display technology and solve the problem that a drift in the threshold voltage of the DTFT influences the driving current. The pixel circuit comprises a reset unit, a driving unit, a control unit, an energy storage unit and a display unit. The driving unit is configured to output a control voltage or a driving current, the control unit is configured to cause a voltage of a second node to be equal to a voltage of a third level end and cause a voltage of a first node to be equal to the control voltage, or cause a voltage of a data signal end to be equal to the voltage of the second node, and the display unit is configured to display gray levels under the control of the driving current, a fourth scanning signal of a fourth scanning signal end and a voltage of a fourth level end. The embodiments of the present disclosure are used to manufacture displays.

### TECHNICAL FIELD

The present disclosure relates to the field of display technology, and in particular, to a pixel circuit and a driving method and display apparatus thereof.

### BACKGROUND

Active Matrix Organic Light Emitting Diodes (AMOLED for short) have advantages such as low power consumption, a low production cost, a wide angle of view, a rapid response speed or the like, and therefore have gradually replaced conventional liquid crystal displays. OLEDs are driven by current, and the working principle thereof is that electrons combine with holes to generate radiation light. That is, electric energy is directly converted into light energy. Therefore, stable current is required to control the light generation during display.

Currently, an OLED is driven by a Drive Thin Film Transistor (DTFT for short), which is generally a P-type switch tube. The DTFT has a gate connected to a data input end V_{data}, a source connected to a power input end V_{DD} with a constant voltage, and a drain connected to the OLED. Due to a voltage difference V_{GS} generated between V_{DD} of the source and V_{data} of the gate, the OLED connected to the drain of the DTFT is turned on, and the driving current of the OLED is I_{OLED}=K(V_{GS}−Vₜₕ)², wherein Vₜₕ is a threshold voltage of the DTFT per se, and K is a constant.

It can be seen from the driving current equation described above, the threshold voltage Vₜₕ of the DTFT will influence the driving current I_{OLED} passing through the OLED. Due to an error in manufacturing process, device aging or the like, the threshold voltage Vₜₕ of the DTFT in various pixel units drifts, which results in an offset in the driving current passing through the OLED, thereby influencing the display effect.

### SUMMARY

Embodiments of the present disclosure provide a pixel circuit and a driving method and display apparatus thereof, which are used to solve the problem in the pixel circuit that a drift in the threshold voltage of the DTFT influences the driving current, which in turn influences the display effect.

In order to achieve the above purpose, the embodiments of the present disclosure use the following technical solutions.

In a first aspect, a pixel circuit is provided, comprising:

a reset unit connected to a first level end, a first scanning signal end, and a first node, and configured to cause a voltage of the first node to be equal to a voltage of the first level end under the control of a first scanning signal of the first scanning signal end;

a driving unit connected to the first node, a second level end, and a third node, and configured to output a control voltage or a driving current via the third node under the control of the voltage of the first node and a voltage of the second level end;

a control unit connected to a second scanning signal end, the first node, the third node, a third scanning signal end, a data signal end, a second node, and a third level end, and configured to cause a voltage of the second node to be equal to a voltage of the third level end and cause the voltage of the first node to be equal to a control voltage output by the third node under the control of a second scanning signal of the second scanning signal end, or cause a voltage of the data signal end to be equal to the voltage of the second node under the control of a third scanning signal of the third scanning signal end;

an energy storage unit connected to the first node and the second node, and configured to store the voltage of the first node and the voltage of the second node; and

a display unit connected to the third node, a fourth scanning signal end, and a fourth level end, and configured to display gray levels under the control of a driving current output by the third node, a fourth scanning signal of the fourth scanning signal end, and a voltage of the fourth level end.

Alternatively, the reset unit comprises a first transistor which is a switch transistor; and

the first transistor has a first electrode connected to the first level end, a second electrode connected to the first node, a gate connected to the first scanning signal end,

wherein the first electrode is one of a source and a drain, and the second electrode is the other of the source and the drain.

Alternatively, the control unit comprises a second transistor, a third transistor, and a fourth transistor which are switch transistors;

the second transistor has a first electrode connected to the third node, a second electrode connected to the first node, and a gate connected to the second scanning signal end;

the third transistor has a first electrode connected to the data signal end, a second electrode connected to the second node, and a gate connected to the third scanning signal end; and

the fourth transistor has a first electrode connected to the third level end, a second electrode connected to the second node, and a gate connected to the second scanning signal end,

wherein the first electrode is one of a source and a drain, and the second electrode is the other of the source and the drain.

Alternatively, the display unit comprises a fifth transistor and an organic light emitting diode, the fifth transistor being a switch transistor;

the fifth transistor has a first electrode connected to the third node, a second electrode connected to a first electrode of the organic light emitting diode, and a gate connected to the fourth scanning signal end;

the organic light emitting diode has a second electrode connected to the fourth level end; and

the first electrode is one of a source and a drain, and the second electrode is the other of the source and the drain.

Alternatively, the driving unit comprises a driving transistor, wherein,

the driving transistor has a first electrode connected to the second level end, a second electrode connected to the third node, and a gate connected to the first node; and

the first electrode is one of a source and a drain, and the second electrode is the other of the source and the drain.

Alternatively, the energy storage unit comprises a capacitor, wherein,

the capacitor has a first electrode connected to the first node, and a second electrode connected to the second node.

Alternatively, the first transistor is a P-type transistor or an N-type transistor.

Alternatively, all of the second transistor, the third transistor and the fourth transistor are P-type transistors or N-type transistors.

Alternatively, the fifth transistor is a P-type transistor or an N-type transistor.

Alternatively, the driving transistor is a P-type transistor or an N-type transistor.

In a second aspect, a display apparatus is provided, comprising any of the pixel circuits described above.

In a third aspect, a method for driving the pixel circuit is provided, comprising:

a first stage in which a reset unit causes a voltage of a first node to be equal to a voltage of a first level end under the control of a first scanning signal of a first scanning signal end;

a second stage in which a driving unit outputs a control voltage via a third node under the control of the voltage of the first node; and a control unit causes the voltage of the first node to be equal to a control voltage output by the third node and causes a voltage of a second node to be equal to a voltage of a third level end under the control of a second scanning signal of a second scanning signal end, wherein the voltage of the first node is stored in an energy storage unit;

a third stage in which the control unit causes a voltage of the second node to be equal to a voltage of a data signal end under the control of a third scanning signal of a third scanning signal end, wherein the voltage of the second node is stored in the energy storage unit; and

a fourth stage in which the driving unit outputs a driving current via the third node under the control of the voltage of the first node; and the display unit displays gray levels under the control of the driving current, a fourth scanning signal of a fourth scanning signal end, and a voltage of a fourth level end.

Alternatively, the reset unit comprises a first transistor which is a switch transistor;

the first transistor has a first electrode connected to the first level end, a second electrode connected to the first node, and a gate connected to the first scanning signal end;

in the first stage, the first transistor is in a turned-on state;

in the second stage, the first transistor is in a turned-off state;

in the third stage, the first transistor is in a turned-off state; and

in the fourth stage, the first transistor is in a turned-off state.

Alternatively, the control unit comprises a second transistor, a third transistor, and a fourth transistor which are switch transistors;

the second transistor has a first electrode connected to the third node, a second electrode connected to the first node, and a gate connected to the second scanning signal end;

the third transistor has a first electrode connected to the data signal end, a second electrode connected to the second node, and a gate connected to the third scanning signal end;

the fourth transistor has a first electrode connected to the third level end, a second electrode connected to the second node, and a gate connected to the second scanning signal end;

in the first stage, the second transistor is in a turned-off state, the third transistor is in a turned-off state, and the fourth transistor is in a turned-off state;

in the second stage, the second transistor is in a turned-on state, the third transistor is in a turned-off state, and the fourth transistor is in a turned-on state;

in the third stage, the second transistor is in a turned-off state, the third transistor is in a turned-on state, and the fourth transistor is in a turned-off state; and

in the fourth stage, the second transistor is in a turned-off state, the third transistor is in a turned-off state, and the fourth transistor is in a turned-off state.

Alternatively, the display unit comprises a fifth transistor and an organic light emitting diode, the fifth transistor being a switch transistor;

the fifth transistor has a first electrode connected to the third node, a second electrode connected to a first electrode of the organic light emitting diode, and a gate connected to the fourth scanning signal end;

in the first stage, the fifth transistor is in a turned-off state;

in the second stage, the fifth transistor is in a turned-off state;

in the third stage, the fifth transistor is in a turned-off state; and

in the fourth stage, the fifth transistor is in a turned-on state;

Alternatively, the first transistor is a P-type transistor or an N-type transistor.

Alternatively, all of the second transistor, the third transistor and the fourth transistor are P-type transistors or N-type transistors.

Alternatively, the fifth transistor is a P-type transistor or an N-type transistor.

The pixel circuit according to the embodiments of the present disclosure and the driving method and display apparatus thereof control the driving current through the reset unit, the driving unit, the control unit and the energy storage unit, so as to control an electroluminescence unit to display gray levels. Before the driving unit of the pixel circuit outputs a driving current, the control unit firstly causes the voltage of the first node to be equal to the control voltage output by the third node and causes the voltage of the second node to be equal to the voltage of the third level end, and then causes the voltage of the data signal end to be equal to the voltage of the second node, and the energy storage unit will maintain the voltage difference between the first node and the second node to be unchanged. Thereby, the voltage of the first node is a difference between the voltage of the second level end and a threshold voltage of the driving unit plus the voltage of the data signal end, and the control voltage output by the third node is a difference between the voltage of the second level end and the threshold voltage of the driving unit. Therefore, a difference between the voltage of the second level end and the voltage of the first node minus the threshold voltage of the driving unit is a constant, when the driving current is output, and thus the driving unit can output a stable driving current via the third node, so as to avoid the influence of the threshold voltage of the driving unit to the driving current, thereby avoiding the influence to the display effect.

### BRIEF DESCRIPTION OF THE DRAWINGS

Next, the accompanying drawings used in the embodiments or the related art will be described briefly in order to more clearly describe the technical solutions in the embodiments of the present disclosure. Obviously, the accompanying drawings described below are merely some embodiments recited in the present disclosure. Other embodiments will be readily apparent to those skilled in the art in light of these accompanying drawings without contributing any creative labor.

FIG. 1 is a schematic structural diagram of a pixel circuit according to an embodiment of the present disclosure;

FIG. 2 is a schematic structural diagram of another pixel circuit according to an embodiment of the present disclosure;

FIG. 3 is a flowchart of a method for driving a pixel circuit according to an embodiment of the present disclosure;

FIG. 4 is a diagram of timing states of a scanning signal according to an embodiment of the present disclosure;

FIG. 5 is a diagram of a direction of current in a pixel circuit in stage t1 according to an embodiment of the present disclosure;

FIG. 6 is a diagram of a direction of current in a pixel circuit in stage t2 according to an embodiment of the present disclosure;

FIG. 7 is a diagram of a direction of current in a pixel circuit in stage t3 according to an embodiment of the present disclosure;

FIG. 8 is a diagram of a direction of current in a pixel circuit in stage t4 according to an embodiment of the present disclosure;

FIG. 9 is a diagram of simulation of timing states of a voltage of a first node a according to an embodiment of the present disclosure;

FIG. 10 is a diagram of simulation of timing states of a voltage of a first node a according to another embodiment of the present disclosure; and

FIG. 11 is a diagram of a relationship between a threshold voltage of a DTFT and a driving current according to an embodiment of the present disclosure.

### DETAILED DESCRIPTION

The technical solutions in the embodiments of the present disclosure will be described clearly and completely below in conjunction with accompanying drawings of the present disclosure. Obviously, the embodiments described herein are merely some of the embodiments of the present disclosure instead of all of the embodiments. Other embodiments obtained by those skilled in the art based on the embodiments of the present disclosure without contributing any creative labor, should be included in the protection scope of the present disclosure.

Transistors used in all of the embodiments of the present disclosure may be thin film transistors or field effect transistors or other devices with the same characteristics. According to the functions of the transistors in the circuits, the transistors used in the embodiments of the present disclosure are primarily switch transistors. As a source and a drain of a transistor used herein are symmetric, the source and the drain are interchangeable. In the embodiments of the present disclosure, in order to distinguish two electrodes except for a gate of the transistor, the source is referred to as a first electrode, and the drain is referred to as a second electrode. It is regulated according to a form of the transistor in the accompanying drawings that an intermediate electrode is a gate, a signal input electrode is a source, and a signal output electrode is a drain. In addition, transistors used in the embodiments of the present disclosure comprise P-type transistors and N-type transistors, wherein a P-type transistor is turned on when a gate thereof is at a low level, and is turned off when the gate thereof is at a high level, and an N-type transistor is turned on when a gate thereof is at a high level and is turned off when the gate thereof is at a low level. Driving transistors comprise P-type transistors and N-type transistors, wherein a P-type transistor is in an amplification state or a saturation state when a gate voltage thereof is at a low level (the gate voltage is smaller than a source voltage) and an absolute value of a difference between the gate voltage and the source voltage is larger than the threshold voltage, and an N-type transistor is in an amplification state or a saturation state when a gate voltage thereof is at a high level (the gate voltage is larger than a source voltage) and an absolute value of a difference between the gate voltage and the source voltage is larger than the threshold voltage.

It should be illustrated that for convenience of clearly describing the technical solutions according to the embodiments of the present disclosure, in the embodiments of the present disclosure, words “first” and “second” or the like are used to distinguish the same or similar items with substantially the same functions and roles, and those skilled in the art should understand that these words “first”, “second” or the like are not intended to define a number and an execution order.

The embodiments of the present disclosure provide a pixel circuit. As shown in FIG. 1, the pixel circuit comprises a reset unit 101, a driving unit 102, a control unit 103, an energy storage unit 104 and a display unit 105.

The reset unit 101 is connected to a first level end V1, a first scanning signal end S1, and a first node a, and is configured to cause a voltage of the first node a to be equal to a voltage of the first level end V1 under the control of a first scanning signal of the first scanning signal end S1;

the driving unit 102 is connected to the first node a, a second level end V2, and a third node c, and is configured to output a control voltage or a driving current via the third node c under the control of the voltage of the first node a and a voltage of the second level end V2;

the control unit 103 is connected to a second scanning signal end S2, the first node a, the third node c, a third scanning signal end S3, a data signal end V_{data}, a second node b, and a third level end V3, and is configured to cause a voltage of the second node b to be equal to a voltage of the third level end V3 and cause the voltage of the first node a to be equal to a control voltage output by the third node b under the control of a second scanning signal of the second scanning signal end S2, or cause a voltage of the data signal end V_{data} to be equal to the voltage of the second node b under the control of a third scanning signal of the third scanning signal end S3;

the energy storage unit 104 is connected to the first node a and the second node b, and is configured to store the voltage of the first node a and the voltage of the second node b; and

the display unit 105 is connected to the third node c, a fourth scanning signal end S4, and a fourth level end V4, and is configured to display gray levels under the control of a driving current output by the third node c, a fourth scanning signal of the fourth scanning signal end S4, and a voltage of the fourth level end V4.

The pixel circuit according to the embodiments of the present disclosure controls the driving current through the reset unit, the driving unit, the control unit and the energy storage unit, so as to control an electroluminescence unit to display gray levels. Before the driving unit of the pixel circuit outputs a driving current, the control unit firstly causes the voltage of the first node to be equal to the control voltage output by the third node and causes the voltage of the second node to be equal to the voltage of the third level end, and then causes the voltage of the data signal end to be equal to the voltage of the second node, and the energy storage unit will maintain the voltage difference between the first node and the second node to be unchanged. Thereby, the voltage of the first node is a difference between the voltage of the second level end and a threshold voltage of the driving unit plus the voltage of the data signal end, and the control voltage output by the third node is a difference between the voltage of the second level end and the threshold voltage of the driving unit. Therefore, a difference between the voltage of the second level end and the voltage of the first node minus the threshold voltage of the driving unit is a constant, when the driving current is output, and thus the driving unit can output a stable driving current via the third node, so as to avoid the influence of the threshold voltage of the driving unit to the driving current, thereby avoiding the influence to the display effect.

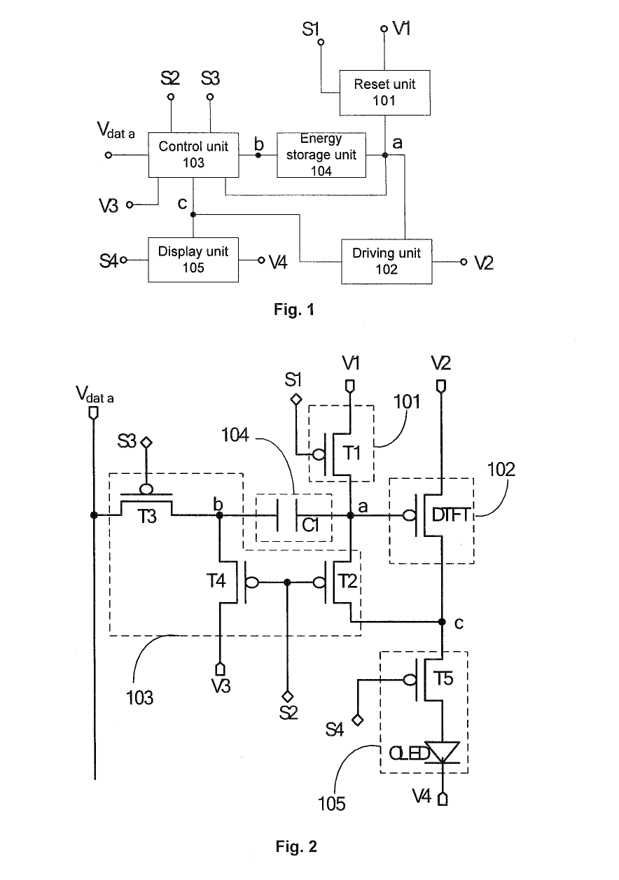

Specifically, as shown in FIG. 2, in the pixel circuit according to the embodiment described above, the reset unit 101 comprises a first transistor T1;

The first transistor T1 has a first electrode connected to the first level end V1, a second electrode connected to the first node a, and a gate connected to the first scanning signal end S1.

The control unit 103 comprises a second transistor T2, a third transistor T3, and a fourth transistor T4;

the second transistor T2 has a first electrode connected to the third node c, a second electrode connected to the first node a, and a gate connected to the second scanning signal end S2;

the third transistor T3 has a first electrode connected to the data signal end V_{data}, a second electrode connected to the second node b, and a gate connected to the third scanning signal end S3; and

the fourth transistor has a first electrode connected to the third level end V3, a second electrode connected to the second node b, and a gate connected to the second scanning signal end S2.

The display unit 105 comprises a fifth transistor T5 and an Organic Light Emitting Diode (OLED);

the fifth transistor T5 has a first electrode connected to the third node c, a second electrode connected to a first electrode of the OLED, and a gate connected to the fourth scanning signal end S4;

the OLED has a second electrode connected to the fourth level end V4.

The driving unit 102 comprises a driving transistor DTFT;

the driving transistor DTFT has a first electrode connected to the second level end V2, a second electrode connected to the third node c, and a gate connected to the first node a.

The energy storage unit 104 comprises a capacitor C1;

the capacitor C1 has a first electrode connected to the first node a, and a second electrode connected to the second node b.

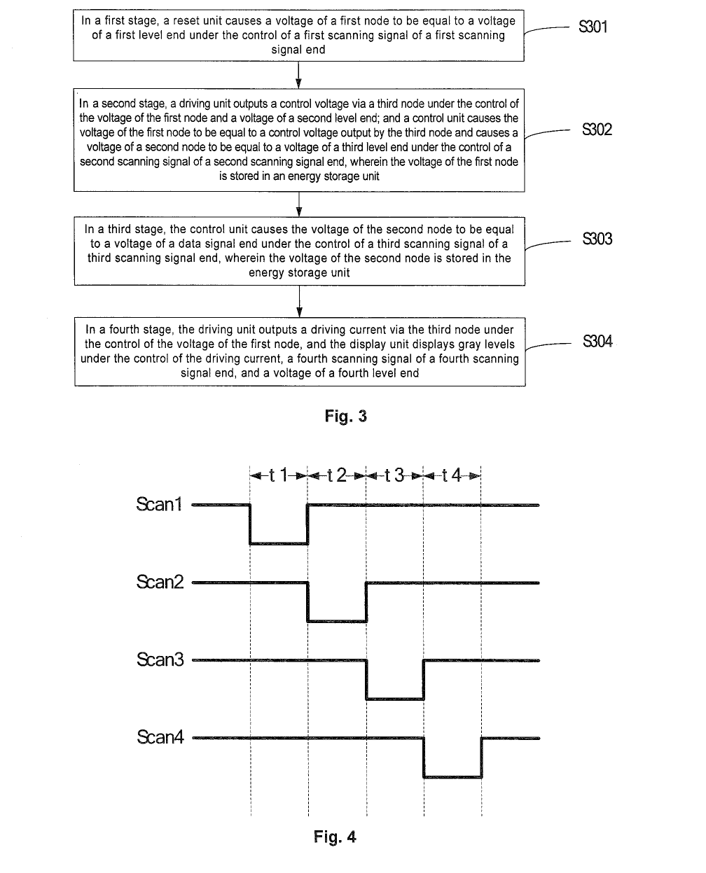

A method for driving a pixel circuit according to an embodiment of the present disclosure is provided, and the driving method according to the embodiment of the present disclosure will be described below in conjunction with the pixel circuit illustrated in FIG. 1. Specifically, as shown in FIG. 3, the method comprises the following steps.

In S301, in a first stage, a reset unit 101 causes a voltage of a first node a to be equal to a voltage of a first level end V1 under the control of a first scanning signal of a first scanning signal end S1;

in S302, in a second stage, a driving unit 102 outputs a control voltage via a third node c under the control of the voltage of the first node a and a voltage of a second level end; and a control unit causes the voltage of the first node a to be equal to a control voltage output by the third node c and causes a voltage of a second node b to be equal to a voltage of a third level end V3 under the control of a second scanning signal of a second scanning signal end S2, wherein the voltage of the first node a is stored in an energy storage unit 104;

in S303, in a third stage, the control unit 103 causes the voltage of the second node b to be equal to a voltage of a data signal end V_{data} under the control of a third scanning signal of a third scanning signal end S3, wherein the voltage of the second node b is stored in the energy storage unit 104; and

in S304, in a fourth stage, the driving unit 102 outputs a driving current via the third node c under the control of the voltage of the first node a, and the display unit 105 displays gray levels under the control of the driving current, a fourth scanning signal of a fourth scanning signal end, and a voltage of a fourth level end.

The method for driving a pixel circuit according to the embodiments of the present disclosure controls the driving current through the reset unit, the driving unit, the control unit and the energy storage unit, so as to control an electroluminescence unit to display gray levels. In the second stage, the control unit firstly causes the voltage of the first node to be equal to the control voltage output by the third node and causes the voltage of the second node to be equal to the voltage of the third level end, and in the third stage, the control unit causes the voltage of the data signal end to be equal to the voltage of the second node, and the energy storage unit will maintain the voltage difference between the first node and the second node to be unchanged. Therefore, in the fourth stage, the voltage of the first node is a difference between the voltage of the second level end and a threshold voltage of the driving unit plus the voltage of the data signal end, and the control voltage output by the third node is a difference between the voltage of the second level end and the threshold voltage of the driving unit. Therefore, when the driving current is output, a difference between the voltage of the second level end and the voltage of the first node minus the threshold voltage of the driving unit is a constant, and thus the driving unit can output a stable driving current via the third node, so as to avoid the influence of the threshold voltage of the driving unit to the driving current, thereby avoiding the influence to the display effect.

Alternatively, the reset unit comprises a first transistor;

the first transistor has a first electrode connected to the first level end, a second electrode connected to the first node, and a gate connected to the first scanning signal end;

in the first stage, the first transistor is in a turned-on state;

in the second stage, the first transistor is in a turned-off state;

in the third stage, the first transistor is in a turned-off state; and

in the fourth stage, the first transistor is in a turned-off state.

Alternatively, the control unit comprises a second transistor, a third transistor, and a fourth transistor;

the second transistor has a first electrode connected to the third node c, a second electrode connected to the first node, and a gate connected to the second scanning signal end;

the third transistor has a first electrode connected to the data signal end, a second electrode connected to the second node, and a gate connected to the third scanning signal end;

the fourth transistor has a first electrode connected to the third level end, a second electrode connected to the second node, and a gate connected to the second scanning signal end;

in the first stage, the second transistor is in a turned-off state, the third transistor is in a turned-off state, and the fourth transistor is in a turned-off state;

in the second stage, the second transistor is in a turned-on state, the third transistor is in a turned-off state, and the fourth transistor is in a turned-on state;

in the third stage, the second transistor is in a turned-off state, the third transistor is in a turned-on state, and the fourth transistor is in a turned-off state; and

in the fourth stage, the second transistor is in a turned-off state, the third transistor is in a turned-off state, and the fourth transistor is in a turned-off state.

Alternatively, the display unit comprises a fifth transistor and an organic light emitting diode,

the fifth transistor has a first electrode connected to the third node c, a second electrode connected to a first electrode of the organic light emitting diode, and a gate connected to the fourth scanning signal end;

in the first stage, the fifth transistor is in a turned-off state;

in the second stage, the fifth transistor is in a turned-off state;

in the third stage, the fifth transistor is in a turned-off state; and

in the fourth stage, the fifth transistor is in a turned-on state;

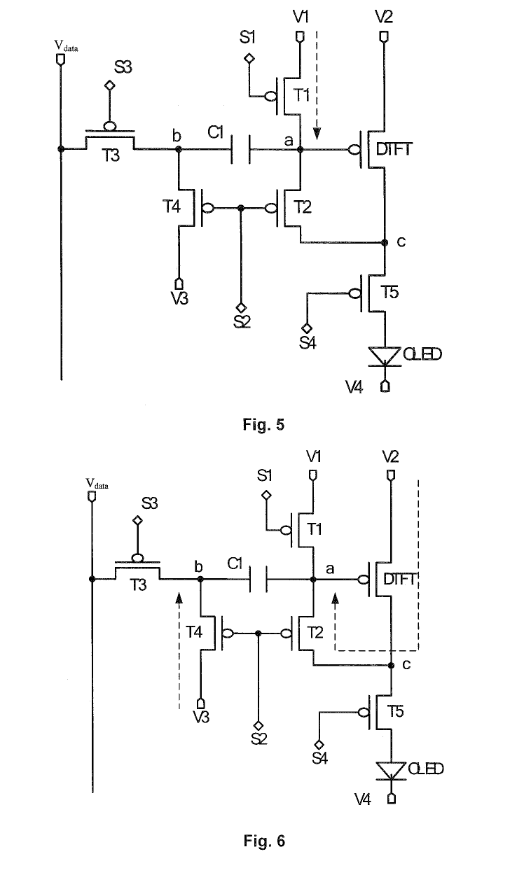

The working principle of a method for driving the pixel circuit corresponding to FIG. 2 and the pixel circuit corresponding to FIG. 3 will be described below with reference to a diagram of timing states illustrated in FIG. 4 by taking all transistors being P-type transistors which are turned-on at a low level and are turned-off at a high level. FIG. 4 illustrates diagrams of timing states of a first scanning signal Scan1 of a first scanning signal end S1, a second scanning signal Scan2 of a second scanning signal end S2, a third scanning signal Scan3 of a third scanning signal end S3, and a fourth scanning signal Scan4 of a fourth scanning single end S4. A first level end V1, a second level end V2, a third level end V3, and a fourth level end V4 provide stable voltages, for example, the first level end V1 and the third level end V3 provide a ground voltage 0, a voltage of a data signal end V_{data} is V_{data}, a threshold voltage of a DTFT is Vₜₕ, and a voltage of the second level end V2 is V_{dd}. As shown in FIG. 5, timing states in four stages are provided. The four stages comprise a first stage t1, a second stage t2, a third stage t3, and a fourth stage t4.

In stage t1, Scan1 is at a low level, Scan2, Scan3, and Scan4 are at high levels, T1 is turned-on, and T2, T3, T4 and T5 are turned-off. In this stage, as Scan1 is at a low level, T1 is turned-on, and as the first level end V1 is connected to a first node a via T1, the first node a is connected to the ground for reset; as Scan2 is at a high level, T2 and T4 are turned-off; as Scan3 is at a high level, T3 is turned-off; and as Scan4 is at a high level, T5 is turned-off. In this stage, a direction of current in the pixel circuit is shown in FIG. 5, i.e., the current flowing from the first level end V1 to the first node a (illustrated as a dotted line and an arrow in this figure).

In stage t2, Scan2 is at a low level, Scan1, Scan3 and Scan4 are at high levels, T2 and T4 are turned-on, and T1, T3 and T5 are turned-off. In this stage, as Scan1 is at a high level, T1 is turned-off; as Scan2 is at a low level, T2 and T4 are turned-on, the second level end V2 charges a capacitor C1 via a DTFT and T2, a voltage of the first node a is V_{dd}−|Vₜₕ|, and a second node b is connected to the third level end V3 via T4 and maintains at a ground voltage 0; and as Scan3 is at a high level, T3 is turned-off. In this stage, a direction of current is shown in FIG. 6, i.e., the current flowing from the third level end V3 to the second node b, and from the second level end V2 to the first node a via the DTFT and T2 (illustrated as dotted lines and arrows in this figure).

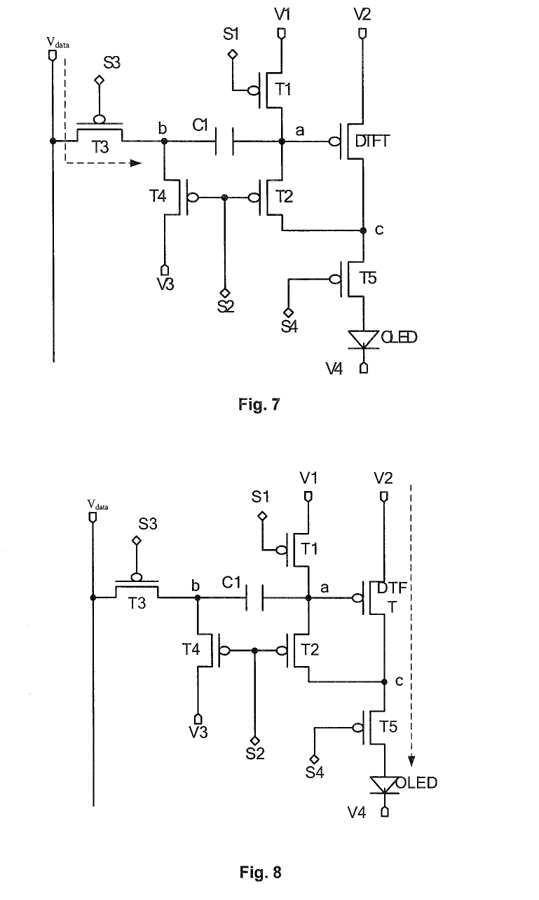

In stage t3, Scan3 is at a low level, Scan1, Scan2, and Scan4 are at high levels, T3 is turned-on, and T1, T2, T4 and T5 are turned-off. In this stage, as Scan1 is at a high level, T1 is turned-off, as Scan2 is at a high level, T2 and T4 are turned-off, and as a result, a first electrode of the capacitor C1 is connected to the first node a at a floating state; and as Scan3 is at a low level, T3 is turned-on, the second node b is connected to the data signal end V_{data} via T3, the data signal end V_{data} charges a second electrode of the capacitor C1 via T3, a voltage of the second node changes from 0 to V_{data}, and as the first electrode of the capacitor C1 is connected at floating state, equal voltage jump occurs at the first electrode of the capacitor C1, and as a result, a voltage of the first node a and the first electrode of the capacitor C1 is V_{dd}−|Vₜₕ|+V_{data}. In this stage, a direction of current is shown in FIG. 7, i.e., the current flowing from the data signal end V_{data} to the second node b (illustrated as a dotted line and an arrow in this figure).

In stage t4, Scan4 is at a low level, Scan1, Scan2, and Scan3 are at high levels, T5 is turned-on, and T1, T2, 13 and T4 are turned-off. In this stage, as Scan4 is at a low level, T5 is turned-on, and the second level end outputs a current to an OLED via the DTFT and T5, and the OLED displays gray levels when the OLED is driven by the current. In this stage, a direction of current is shown in FIG. 8, i.e., the current flowing from the second level end V2 to the fourth level end V4 via the DTFT. T5 and the OLED (illustrated as a dotted line and an arrow in this figure).

A current I_{OLED} flowing into the OLED may be obtained by the following DTFT saturation current equation:

$$\begin{matrix}{I}_{OLED} = {K ( {V}_{GS} - {V}_{th} )}^{2} \\ = {K [ {V}_{dd} - ( {V}_{dd} - \vert {V}_{th} \vert + {V}_{data} ) - {V}_{th} ]}^{2} \\ = {K ( {V}_{data} )}^{2}\end{matrix}$$

wherein V_{GS} is a voltage difference between a source and a gate of the DTFT,

$$K = μ {C}_{OX} \frac{W}{L} ,$$

μ and Cₒₓ are process constants, W is a channel width of the DTFT. L is a channel length of a thin film transistor, and W and L are constants which may be selectively designed.

It can be seen from the above equation that the working current I_{OLED} is not influenced by Vₜₕ, and is only related to V_{data}. This completely solves the problem that a drift occurs in the threshold voltage (Vₜₕ) of the driving transistor DTFT due to manufacturing processes and long-time operations, eliminates the influence to I_{OLED}, and ensures a normal operation of the OLED.

Further, all of the transistors in the pixel circuits in the above embodiments may also be N-type transistors which are turned-on at a high level. If all of the transistors are N-type transistors, it only needs to re-adjust timing states of various input signals and voltages of level ends in the pixel circuits. For example, the first scanning signal end is adjusted to provide a high level in stage t1, and provide low levels in stages t2, t3 and t4. Other signals are adjusted as timing signals with opposite phases.

Further, N-type transistors and P-type transistors may also be used in the above pixel circuits at the same time. At this time, it needs to ensure that transistors controlled by the same timing signal or voltage are of the same type in the pixel circuit. Of course, those skilled in the art can make reasonable variations according to the embodiments of the present discourse, and therefore these variations should be included in the protection scope of the present disclosure. However, in consideration of the manufacturing processes of the transistors, as active layers of different types of transistors have different doping materials, it is more beneficial to simplify the manufacturing processes of the pixel circuit by using the same type of transistors in the pixel circuit.

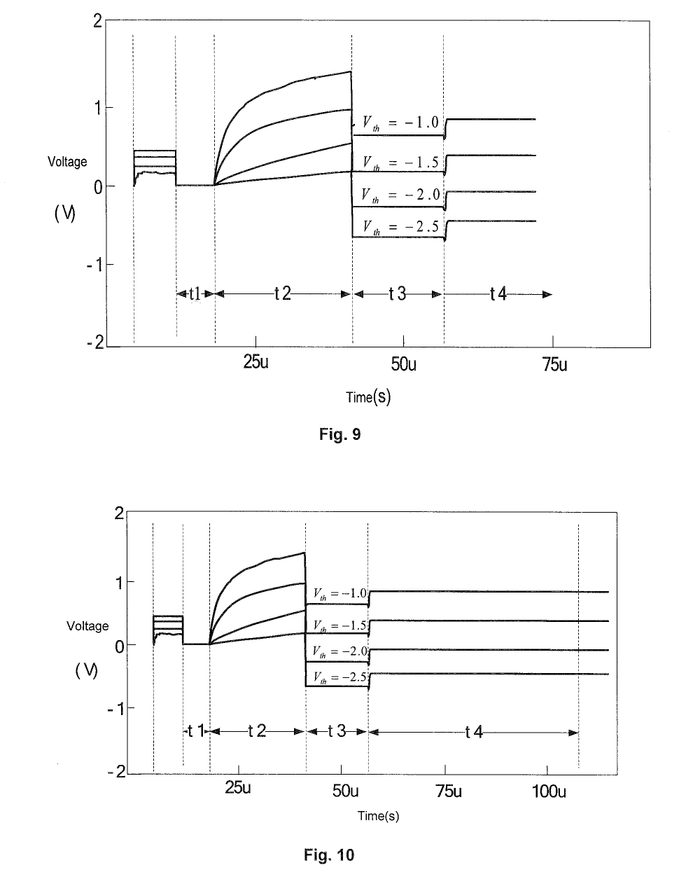

A simulated experiment result of the pixel circuit according to the above embodiment is provided hereinafter. Specifically, voltage variation conditions of the first node a in stages t1-t4 when threshold voltages Vₜₕ of the DTFT are −1.0V, −1.5V, −2.0V and −2.5V respectively are shown in FIG. 9.

In stage t2, a voltage of point a firstly rises gradually, and then tends to be stable. When the t2 stage ends, a difference between voltages of point a corresponding to different threshold voltages Vₜₕ is a difference between the threshold voltages Vₜₕ. This simulated result verifies the conclusion in the above embodiment that in stage t2, the second level end V2 charges the capacitor C1 via the DTFT and T2, and the voltage of the first node a is V_{dd}−|Vₜₕ|.

In stage t3, voltage jump occurs at point a, and a difference between voltages of point a corresponding to different threshold voltages Vₜₕ is still a difference between the threshold voltages Vₜₕ. The simulated result verifies the conclusion in the above embodiment that in stage t3, as the data signal end V_{data} charges the second electrode of the capacitor via T3, a voltage of the second node changes from 0 to V_{data}, and the first electrode of the capacitor C1 is connected at a floating state, equal voltage jump occurs at the first electrode of the capacitor C1, and as a result, a voltage of the first node a and the first electrode of the capacitor C1 is V_{dd}−|Vₜₕ|+V_{data}.

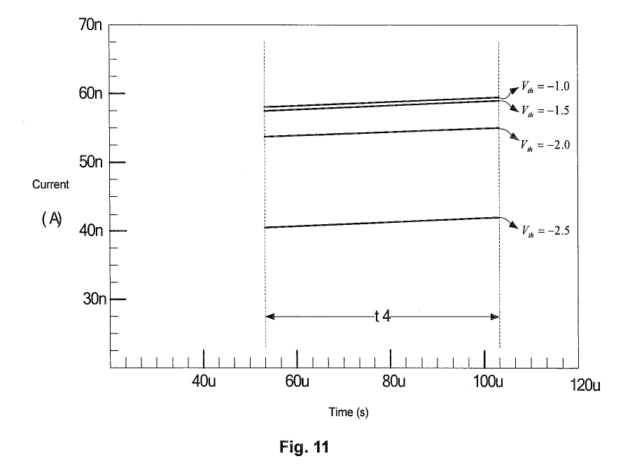

Further, with reference to FIGS. 10 and 11, the pixel circuit in the above embodiment is simulated by taking a time length of the stage t4 being 50 us as an example. Voltage variation conditions of the first node a in stages t1-t4 when threshold voltages Vₜₕ of the DTFT are −1.0V, −1.5V, −2.0V and −2.5V respectively are shown in FIG. 10. Variation conditions of a driving current in the pixel circuit in stage t4 when threshold voltages Vₜₕ of the DTFT are −1.0V, −1.5V, −2.0V and −2.5V respectively are shown in FIG. 11. It can be seen from FIG. 11 that for different threshold voltages Vₜₕ, a maximum value of the driving current I_{OLED} is 59 nA, and a minimum value of the driving current I_{OLED} is 40 nA. A variation range of the driving current I_{OLED} in the pixel circuit in the above simulated experiment is less than 19 nA. This variation range is small enough for the pixel circuit, and complies with the requirements of the pixel circuit for the stable current. At the same time, the conclusion that the working current I_{OLED} is not influenced by Vₜₕ in the above embodiment is also verified.

An embodiment of the present disclosure provides a display apparatus, comprising the pixel circuit as described in any of the embodiments.

Further, the display apparatus may be any product or component having a display function such as an electronic paper, a mobile phone, a tablet, a television, a display, a notebook computer, a digital photo frame, a navigator or the like.

The pixel circuit in the display apparatus according to the embodiment of the present disclosure controls the driving current through the reset unit, the driving unit, the control unit and the energy storage unit, so as to control an electroluminescence unit to display gray levels. When the driving unit of the pixel circuit outputs a driving current, the voltage of the first node is a difference between the voltage of the second level end and the threshold voltage of the driving unit plus the voltage of the data signal end, and thus the difference between the voltage of the second level end and the voltage of the first node is a constant which is unrelated to the threshold voltage of the driving unit, i.e., a difference between an input voltage of the driving unit and the control voltage of the driving unit is a constant which is unrelated to the threshold voltage of the driving unit. Therefore, the driving unit can output a stable driving current via the third node, so as to avoid the influence of the threshold voltage of the driving unit to the driving current, thereby avoiding the influence to the display effect.

The above description is merely specific embodiments of the present disclosure, but the protection scope of the present disclosure is not limited thereto. Changes or substitutions, which can be obviously envisaged by those skilled persons in the art within the technical scope of the present disclosure, should be included in the scope of the present disclosure. Therefore, the protection scope of the present disclosure should be defined by the protection scope of the claims.

I/We claim:

1. A pixel circuit, comprising:
a reset unit connected to a first level end, a first scanning signal end, and a first node, and configured to cause a voltage of the first node to be equal to a voltage of the first level end under the control of a first scanning signal of the first scanning signal end;
a driving unit connected to the first node, a second level end, and a third node, and configured to output a control voltage or a driving current via the third node under the control of the voltage of the first node and a voltage of the second level end;
a control unit connected to a second scanning signal end, the first node, the third node, a third scanning signal end, a data signal end, a second node, and a third level end, and configured to cause a voltage of the second node to be equal to a voltage of the third level end and cause the voltage of the first node to be equal to the control voltage output by the third node under the control of a second scanning signal of the second scanning signal end, or cause a voltage of the data signal end to be equal to the voltage of the second node under the control of a third scanning signal of the third scanning signal end;
an energy storage unit connected to the first node and the second node, and configured to store the voltage of the first node and the voltage of the second node; and
a display unit connected to the third node, a fourth scanning signal end, and a fourth level end, and configured to display gray levels under the control of the driving current output by the third node, a fourth scanning signal of the fourth scanning signal end, and a voltage of the fourth level end.

2. The pixel circuit according to claim 1, wherein the reset unit comprises a first transistor which is a switch transistor; and
the first transistor has a first electrode connected to the first level end, a second electrode connected to the first node, a gate connected to the first scanning signal end, wherein the first electrode is one of a source and a drain, and the second electrode is the other of the source and the drain.

3. The pixel circuit according to claim 1, wherein the control unit comprises a second transistor, a third transistor, and a fourth transistor which are switch transistors;
the second transistor has a first electrode connected to the third node, a second electrode connected to the first node, and a gate connected to the second scanning signal end;
the third transistor has a first electrode connected to the data signal end, a second electrode connected to the second node, and a gate connected to the third scanning signal end; and
the fourth transistor has a first electrode connected to the third level end, a second electrode connected to the second node, and a gate connected to the second scanning signal end,
wherein the first electrode is one of a source and a drain, and the second electrode is the other of the source and the drain.

4. The pixel circuit according to claim 1, wherein the display unit comprises a fifth transistor and an organic light emitting diode, the fifth transistor being a switch transistor;
the fifth transistor has a first electrode connected to the third node, a second electrode connected to a first electrode of the organic light emitting diode, and a gate connected to the fourth scanning signal end;
the organic light emitting diode has a second electrode connected to the fourth level end; and
the first electrode is one of a source and a drain, and the second electrode is the other of the source and the drain.

5. The pixel circuit according to claim 1, wherein the driving unit comprises a driving transistor, wherein,
the driving transistor has a first electrode connected to the second level end, a second electrode connected to the third node, and a gate connected to the first node; and
the first electrode is one of a source and a drain, and the second electrode is the other of the source and the drain.

6. The pixel circuit according to claim 1, wherein the energy storage unit comprises a capacitor, wherein,
the capacitor has a first electrode connected to the first node, and a second electrode connected to the second node.

7. The pixel circuit according to claim 2, wherein the first transistor is a P-type transistor or an N-type transistor.

8. The pixel circuit according to claim 3, wherein all of the second transistor, the third transistor and the fourth transistor are P-type transistors or N-type transistors.

9. The pixel circuit according to claim 4, wherein the fifth transistor is a P-type transistor or an N-type transistor.

10. The pixel circuit according to claim 5, wherein the driving transistor is a P-type transistor or an N-type transistor.

11. A display apparatus, comprising the pixel circuit according to claim 1.

12. A method for driving the pixel circuit according to claim 1, comprising:
a first stage in which the reset unit causes the voltage of the first node to be equal to the voltage of the first level end under the control of the first scanning signal of the first scanning signal end;
a second stage in which the driving unit outputs the control voltage via the third node under the control of the voltage of the first node; and the control unit causes the voltage of the first node to be equal to the control voltage output by the third node and causes the voltage of a second node to be equal to the voltage of the third level end under the control of the second scanning signal of a second scanning signal end, wherein the voltage of the first node is stored in the energy storage unit;
a third stage in which the control unit causes the voltage of the second node to be equal to the voltage of the data signal end under the control of the third scanning signal of the third scanning signal end, wherein the voltage of the second node is stored in the energy storage unit; and
a fourth stage in which the driving unit outputs the driving current via the third node under the control of the voltage of the first node; and the display unit displays gray levels under the control of the driving current, the fourth scanning signal of the fourth scanning signal end, and the voltage of the fourth level end.

13. The method according to claim 12, wherein the reset unit comprises a first transistor which is a switch transistor;
the first transistor has a first electrode connected to the first level end, a second electrode connected to the first node, and a gate connected to the first scanning signal end;
in the first stage, the first transistor is in a turned-on state;
in the second stage, the first transistor is in a turned-off state;
in the third stage, the first transistor is in a turned-off state; and
in the fourth stage, the first transistor is in a turned-off state.

14. The method according to claim 12, wherein the control unit comprises a second transistor, a third transistor, and a fourth transistor which are switch transistors;
the second transistor has a first electrode connected to the third node, a second electrode connected to the first node, and a gate connected to the second scanning signal end;
the third transistor has a first electrode connected to the data signal end, a second electrode connected to the second node, and a gate connected to the third scanning signal end;
the fourth transistor has a first electrode connected to the third level end, a second electrode connected to the second node, and a gate connected to the second scanning signal end;
in the first stage, the second transistor is in a turned-off state, the third transistor is in a turned-off state, and the fourth transistor is in a turned-off state;
in the second stage, the second transistor is in a turned-on state, the third transistor is in a turned-off state, and the fourth transistor is in a turned-on state;
in the third stage, the second transistor is in a turned-off state, the third transistor is in a turned-on state, and the fourth transistor is in a turned-off state; and
in the fourth stage, the second transistor is in a turned-off state, the third transistor is in a turned-off state, and the fourth transistor is in a turned-off state.

15. The method according to claim 12, wherein the display unit comprises a fifth transistor and an organic light emitting diode, the fifth transistor being a switch transistor;
the fifth transistor has a first electrode connected to the third node, a second electrode connected to a first electrode of the organic light emitting diode, and a gate connected to the fourth scanning signal end;
in the first stage, the fifth transistor is in a turned-off state;
in the second stage, the fifth transistor is in a turned-off state;
in the third stage, the fifth transistor is in a turned-off state; and
in the fourth stage, the fifth transistor is in a turned-on state;

16. The method according to claim 13, wherein the first transistor is a P-type transistor or an N-type transistor.

17. The method according to claim 14, wherein all of the second transistor, the third transistor and the fourth transistor are P-type transistors or N-type transistors.

18. The method according to claim 15, wherein the fifth transistor is a P-type transistor or an N-type transistor.
